(19) United States
(12) Patent Application Publication
(10) Pub. No.: US 2026/0067663 A1
(43) Pub. Date: Mar. 5, 2026

(54) ELECTRONIC DEVICE, METHOD, AND NON-TRANSITORY COMPUTER READABLE STORAGE MEDIUM FOR MAINTAINING PROTOCOL DATA UNIT SESSION

(71) Applicant: SAMSUNG ELECTRONICS CO., LTD., Suwon-si (KR)

(72) Inventors: Van Hau TRUONG, Bac Ninh Province (VN); Van Hung NGUYEN, Bac Ninh Province (VN); Duc Doan NGUYEN, Bac Ninh Province (VN); The Thoi NGUYEN, Bac Ninh Province (VN); Van Thinh NGUYEN, Bac Ninh Province (VN)

(21) Appl. No.: 19/227,149

(22) Filed: Jun. 3, 2025

(30) Foreign Application Priority Data
Sep. 4, 2024 (KR) 10-2024-0120389

(51) Int. Cl. H04W 4/90; H04W 4/20

(52) U.S. Cl. CPC H04W 4/90; H04W 4/20

(57) ABSTRACT

An example electronic device may include communication circuitry, memory including storing instructions, and at least one processor including processing circuitry. The instructions, when executed by the at least one processor individually and/or collectively, may cause the electronic device to detect an event for an emergency situation, transmit a registration request message including on-demand S-NSSAI to a mobility management entity, receive a registration accept message including the on-demand S-NSSAI, transmit an establishment request message for a PDU session corresponding to the on-demand S-NSSAI to the mobility management entity, receive an establishment accept message for the PDU session from the mobility management entity, and in response to receiving the establishment accept message, transmit dummy data to a user data entity via the PDU session until an end of the event to maintain the PDU session.

### CROSS-REFERENCE TO RELATED APPLICATION

This application is based on and claims priority under 35 U.S.C. § 119(a) of a Korean patent application number 10-2024-0120389, filed on Sep. 4, 2024, in the Korean Intellectual Property Office, the disclosure of which is hereby incorporated by reference herein in its entirety.

### TECHNICAL FIELD

Certain example embodiments may relate to an electronic device, a method, and/or a non-transitory computer readable storage medium for maintaining a protocol data unit session.

### BACKGROUND ART

A network slice means a technology that separates one physical network into a plurality of independent virtual networks to meet different service requirements, by. Each network slice is designed and managed to meet a performance need of a specific service or an application. A network operator may efficiently use a network resource via the network slice.

The above-described information may be provided as a related art for the purpose of helping understanding of the present disclosure. No argument or decision is made as to whether any of the above description may be applied as a prior art related to the present disclosure.

### SUMMARY

An example electronic device is provided. An example electronic device may comprise communication circuitry. The example electronic device may comprise memory comprising one or more storage media, storing instructions. The example electronic device may comprise at least one processor comprising processing circuitry. The instructions, when executed by the at least one processor individually and/or collectively, may cause the electronic device to detect an event for an emergency situation. The instructions, when executed by the at least one processor individually and/or collectively, may cause the electronic device to transmit, via the communication circuitry, a registration request message including on-demand single network slice selection assistance information (S-NSSAI) for the event to a mobility management entity. The instructions, when executed by the at least one processor individually and/or collectively, may cause the electronic device to receive, via the communication circuitry, a registration accept message including the on-demand S-NSSAI. The instructions, when executed by the at least one processor individually and/or collectively, may cause the electronic device to transmit, via the communication circuitry, an establishment request message for a protocol data unit (PDU) session corresponding to the on-demand S-NSSAI to the mobility management entity. The instructions, when executed by the at least one processor individually and/or collectively, may cause the electronic device to receive, via the communication circuitry, an establishment accept message for the PDU session from the mobility management entity. The instructions, when executed by the at least one processor individually and/or collectively, may cause the electronic device to, in response to receiving the establishment accept message, transmit dummy data to a user data entity via the PDU session until an end of the event to maintain the PDU session. The dummy data may be used to reset a PDU session inactivity timer before the PDU session inactivity timer for the PDU session expires.

A method is provided. An example method may be performed by an electronic device with communication circuitry. The example method may comprise detecting an event for an emergency situation. The example method may comprise transmitting, via the communication circuitry, a registration request message including on-demand single network slice selection assistance information (S-NSSAI) for the event to a mobility management entity. The example method may comprise receiving, via the communication circuitry, a registration accept message including the on-demand S-NSSAI. The example method may comprise transmitting, via the communication circuitry, an establishment request message for a protocol data unit (PDU) session corresponding to the on-demand S-NSSAI to the mobility management entity. The example method may comprise receiving, via the communication circuitry, an establishment accept message for the PDU session from the mobility management entity. The example method may comprise in response to receiving the establishment accept message, transmitting dummy data to a user data entity via the PDU session until an end of the event to maintain the PDU session. The dummy data may be used to reset a PDU session inactivity timer before the PDU session inactivity timer for the PDU session expires.

An example non-transitory computer readable storage medium is provided. The example non-transitory computer readable storage medium may store one or more programs. The one or more programs may comprise instructions to, when executed by an electronic device with communication circuitry, cause the electronic device to detect an event for an emergency situation. The one or more programs may comprise instructions to, when executed by the electronic device, cause the electronic device to transmit, via the communication circuitry, a registration request message including on-demand single network slice selection assistance information (S-NSSAI) for the event to a mobility management entity. The one or more programs may comprise instructions to, when executed by the electronic device, cause the electronic device to receive, via the communication circuitry, a registration accept message including the on-demand S-NSSAI. The one or more programs may comprise instructions to, when executed by the electronic device, cause the electronic device to transmit, via the communication circuitry, an establishment request message for a protocol data unit (PDU) session corresponding to the on-demand S-NSSAI to the mobility management entity. The one or more programs may comprise instructions to, when executed by the electronic device, cause the electronic device to receive, via the communication circuitry, an establishment accept message for the PDU session from the mobility management entity. The one or more programs may comprise instructions to, when executed by the electronic device, cause the electronic device to, in response to receiving the establishment accept message, transmit dummy data to a user data entity via the PDU session until an end of the event to maintain the PDU session. The dummy data may be used to reset a PDU session inactivity timer before the PDU session inactivity timer for the PDU session expires.

### BRIEF DESCRIPTION OF THE DRAWINGS

FIG. 1A illustrates an example of a communication system.

FIG. 1B illustrates an example of a core network.

FIG. 2 illustrates an example of operations of a terminal using a network slice.

FIG. 3 illustrates an example of operations of an electronic device for maintaining a protocol data unit (PDU) session.

FIG. 4 illustrates an example of an electronic device building a data set according to a user setting.

FIG. 5 illustrates an example of operations of an electronic device building a data set.

FIG. 6 illustrates an example of an electronic device receiving a notification message from a wearable device and an internet of things (IOT) device.

FIG. 7 illustrates an example of an electronic device providing a seamless service to a user.

FIG. 8 illustrates an example of operations of an electronic device for maintaining a protocol data unit (PDU) session.

FIG. 9 illustrates an example of a screen including a user interface for setting a function for maintaining a protocol data unit (PDU) session of an electronic device.

FIG. 10 is a block diagram of an example electronic device in a network environment according to various embodiments.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to data (e.g., data, information, heart rate data, IMU data, blood pressure data, a data set, a data packet, a signal, or a message), a term referring to a value (e.g., a threshold value, or a data value), a term for a calculation state (e.g., an operation, a process, or a procedure), a term referring to an object, a term referring to network entities, and a term referring to a component of a device, and the like used in the following description are exemplified for convenience of a description. Therefore, the present disclosure is not limited to terms described later, and another term having an equivalent technical meaning may be used.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

The present disclosure describes various embodiments, by using terms used in some communication standards (e.g., 3rd Generation Partnership Project (3GPP), European Telecommunications Standards Institute (ETSI), an extensible radio access network (xRAN), and an open-radio access network (O-RAN), but this is only an example for a description. Various embodiments of the present disclosure may be easily modified and applied in another communication system.

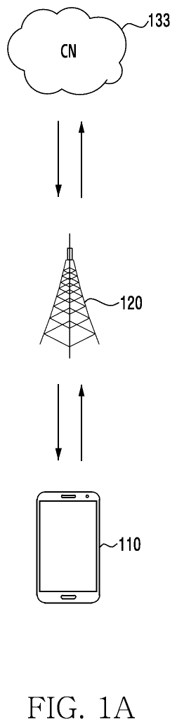

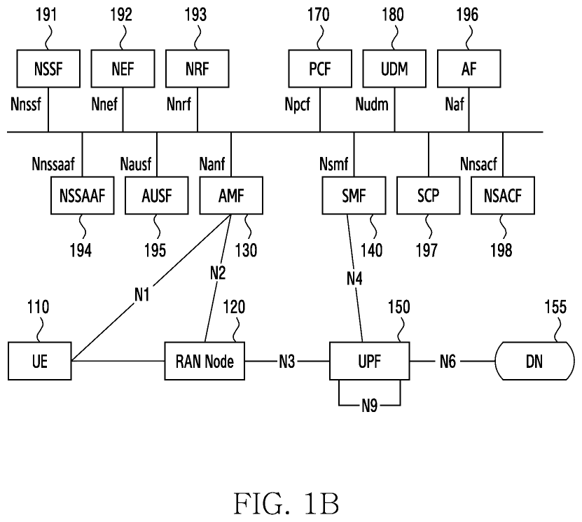

FIG. 1A illustrates an example of a communication system.

Referring to FIG. 1A, a communication system 100 may include a terminal 110. The terminal 110 is a device used by a user, and perform communication with a base station 120 via a wireless channel. A link facing the terminal 110 from the base station 120 is referred to as a downlink (DL), and a link facing the base station 120 from the terminal 110 is referred to as an uplink (UL). In addition, although not illustrated in FIG. 1A, the terminal 110 and another terminal may communicate with each other via the wireless channel. At this time, a device-to-device link (D2D) between the terminal 110 and the other terminal is referred to as a sidelink, and the sidelink may be used interchangeably with a PC5 interface. In some other embodiments, the terminal 110 may be operated without involvement of the user. According to an embodiment, the terminal 110, which is a device performing machine type communication (MTC), may not be carried by the user. In addition, according to an embodiment, the terminal 110 may be a narrowband (NB)-internet of things (IoT) device. In addition to a terminal, the terminal 110 may be referred to as ‘user equipment (UE)’, ‘customer premises equipment (CPE)’, a ‘mobile station’, a ‘subscriber station’, a ‘remote terminal’, a ‘wireless terminal’, an ‘electronic device’, a ‘user device’, or another term having the same technical meaning. Hereinafter, in describing mobility of the terminal of the present disclosure, the terminal 110 is described by being referred to as the UE, but it is of course possible that other terms may be used according to a communication environment or an embodiment.

The base station 120 is a network infrastructure providing wireless access to the terminal 110. The base station 120 has coverage defined based on a distance at which a signal may be transmitted. The base station 120 may be referred to as an ‘RAN node’, a ‘network node’, an ‘access point (AP)’ in terms of providing an access network (AN) in addition to a base station, or may be referred to as an ‘eNodeB (eNB)’, a ‘5th generation node (5th generation node)’, a ‘next generation node B (gNB)’, a ‘wireless point’, a ‘transmission/reception point (TRP)’ or another term with an equivalent technical meaning in terms of a supported radio access technology (RAT).

Although a single network entity is illustrated in FIG. 1A, embodiments of the present disclosure are not limited thereto. For example, the base station 120 may be implemented with a distributed deployment according to a central unit (CU) configured to perform a function of upper layers (e.g., PDCP, and RRC), and a distributed unit (DU) configured to perform a function of lower layers (e.g., RLC, MAC, and PHY) of an access network. For example, in order to reduce an installation cost and increase providable cell coverage, the base station 120 may be implemented with geographically distributed DUs and RUs.

A core network 133 may be configured to connect the base station 120 to a data network. The core network 133 may include various network entities for managing mobility, session management, policy management, and/or a data network connection, and each network entity may indicate a node defining a specific network function. For example, the core network 133, which is a set of network entities for a LTE access network, may be referred to as an evolved packet core (EPC) (or an evolved packet system (EPS)). For example, the core network 133, which is a set of network entities for an NR access network, may be referred to as a 5th generation core (5GC) (or 5th generation system (5GS)). As an example of the core network 133, 5GC is described in detail via FIG. 1B.

FIG. 1B illustrates an example of a core network.

Referring to FIG. 1B, UE exemplifies the terminal 110 of FIG. 1A and an RAN Node exemplifies the base station 120 of FIG. 1B. Network entities of the core network 133 may include various network functions (NFs). The terminal 110 and the base station 120 may communicate with NFs of the core network. For example, the core network 133 may include an access and mobility management function (AMF) 130, a session management function (SMF) 140, a user plane function (UPF) 150, a policy and charging function (PCF) 170, and a unified data management (UDM) 180.

The AMF 130 may provide a function for access and mobility management in a unit of UE (e.g., the terminal 110), and may be basically connected to one AMF per one UE. Specifically, the AMF 130 may support a function of signaling between CN (e.g., core network 133) nodes for mobility between 3GPP access networks, termination of a radio access network (RAN) control plane (CP) interface (i.e., a N2 interface), termination N1 of NAS signaling, non-access stratum (NAS) signaling security (NAS ciphering, and integrity protection), access stratum (AS) security control, registration management (registration area management), connection management, idle mode UE reachability (including control and performance of paging retransmission), mobility management control (subscription and a policy), support for intra-system mobility and inter-system mobility, support for network slicing, SMF selection, lawful intercept (for an AMF event and an interface to an LI system), providing a delivery of session management (SM) message between UE and a SMF (e.g., the SMF 140), a transparent proxy for routing SM message, access authentication, access authorization including roaming right check, providing a delivery of a short message service (SMSF) message between UE and a short message service function (SMSF), a security anchor function (SAF), and/or security context management (SCM), and the like. A portion or all of functions of the AMF 130 may be supported in a single instance of one AMF. According to embodiments, the AMF 130 may select an NF among a plurality of NFs. For example, the AMF 130 may perform SMF selection or a policy charging function (PCF) selection.

The SMF 140 may provide a session management function. In case that UE (e.g., the terminal 110) has a plurality of sessions, each session may be managed by a different SMF. Specifically, the SMF 140 may support a function of the session management (e.g., establishment, modification, and termination of sessions, including maintenance of a tunnel between the UPF 150 and AN nodes (e.g., the base station 120)), UE IP address allocation and management (Optionally including authentication), selection and control of a UP function, traffic steering setting for routing traffic from UPF to an appropriate destination, termination of an interface facing policy control functions, enforcing a control portion of a policy and quality of service (QoS), lawful intercept (for an interface to an SM event and a LI system), termination of a SM portion of a NAS message, a downlink data notification, an initiator of AN specific SM information (delivering to an AN node via N2 through AMF), determination of SSC mode of a session (e.g., a SSC mode 2, a SSC mode 3), a roaming function, and the like. UPF selection according to embodiments may be performed by the SMF 140. A portion or all of functions of the SMF 140 may be supported in a single instance of one SMF. According to embodiments, the SMF 140 may select an NF among a plurality of NFs. For example, the SMF 140 may perform UPF selection or PCF selection.

The UPF 150 may transmit a downlink PDU received from a DN 155 to the terminal 110 via the base station 120, or an uplink PDU received from the terminal 110 via the base station 120 to the DN 155. Specifically, the UPF 150 may support a function of an anchor point for intra/inter RAT mobility, an external PDU session point of an interconnect to a data network, a packet routing and forwarding, a user plane portion of a packet inspection and policy rule enforcement, lawful intercept, traffic usage reporting, an uplink classifier for supporting routing of a traffic flow to a data network, a branch point for supporting a multi-homed PDU session, QoS handling for a user plane (e.g., packet filtering, gating, enforcement of an uplink/a downlink rate), uplink traffic verification (SDF mapping between a service data flow (SDF) and a QoS flow), transport level packet marking in an uplink and an downlink, downlink packet buffering, and downlink data notification triggering, and the like. A portion or all of functions of the UPF 150 may be supported in a single instance of one UPF.

The DN 155 indicates an Internet network for accessing an external communication network. For example, the DN 155 means an operator service, an Internet access, or a third party service. The DN 155 transmits a downlink protocol data unit (PDU) to the UPF 150, or receives a PDU transmitted from the terminal 110 from the UPF 150.

The PCF 170 may provide a function of determining a policy such as mobility management session management, and the like, by receiving information on a packet flow from an application server. Specifically, PCF 170 supports a function of providing a unified policy framework for controlling a network operation, providing a policy rule so that CP function(s) (e.g., the AMF 130, the SMF 140, and the like) may enforce a policy rule, and implementing a front end for accessing related subscription information for policy decision in a user data repository (UDR), and the like.

The UDM 180 stores subscription data, policy data, and the like of a user. The UDM 180 may include two parts, that is, an application front end (FE) and a user data repository (UDR).

The core network 133 may include various NFs in addition to the above-described network entities/network functions. For example, core network 133 may include a network slice selection function (NSSF) 191, a network exposure function (NEF) 192, a network repository function (NRF) 193, network slice-specific authentication and authorization (NSSAAF) 194, an authentication server function (AUSF) 195, an application function (AF) 196, a service communication proxy (SCP) 197, and a network slice admission control function (NSACF) 198.

The NSSF 191 may support a function of selecting a network slice instance set that provides a service to the terminal 110. The NSSF 191 may determine allowed network slice selection assistance information (NSSAI) and, if needed, may determine mapping for subscribed single (S)-NSSAI. The NSSF 191 may determine configured NSSAI and, if needed, may determine mapping for the subscribed S-NSSAI. The NSSF 191 may determine a set of AMF used to service UE, or may determine, based on configuration, by inquiring an AMF list to a NRF. The NSSF 191 may provide support for network slice limitation and network slice instance limitation based on NWDAF analysis.

The NEF 192 may provide a means for safely exposing services and capabilities for, for example, a 3rd party, internal exposure/re-exposure, an application function, and edge computing provided by 3GPP NFs. The NEF 192 receives information from another NF or based on a capability to be exposed to the other NF. The NEF 192 may store information received as structured data, by using a standardized interface to a data storage network function. The stored information may be re-exposed by the NEF 192 to another NF and an AF (e.g., the AF 196) and may be used for another purpose such as analysis, and the like.

The NRF 193 may support a service discovery function. The NRF 193 may receive a NF discovery request from NF instance and provide information on found NF instance to the NF instance. In addition, the NRF193 maintains available NF instances and a service they support. The discovery of the NF and selection of the NF may be performed on its own in a specific NF or may be performed with reference to the NRF 193.

The NSSAAF 194 may support authentication and an authorization function for each network slice.

The AUSF 195 stores data for authentication of the UE (e.g., the terminal 110).

The AF 196 may interact with a 3GPP core network to provide a service (e.g., support functions of an application impact on traffic routing, network capability exposure access, interaction with a policy framework for policy control, and the like).

The SCP 197 may perform functions of indirect communication, a delegated discovery, a message delivery and routing to a target NF/NF service, a message delivery and routing to a next hop SCP, communication security (e.g., NF service consumer approval for accessing NF service producer API), load balancing, monitoring, and overload control, and the like. The SCP 197 may be disposed in a distributed manner. For example, two or more SCPs may exist in a communication path between NF services. Messages may be routed via SCPs. For example, the SCP 197 may register a profile in an NRF (e.g., the NRF 193) so that the message may be routed (i.e., the next SCP hop search). For another example, the SCP 197 may use a local configuration. A portion or all of functions of the SCP 197 may be supported in a single instance of one AMF.

The NSACF 198 may monitor and control the number of registered UEs for each network slice for a network slice to which network slice admission control is applied.

In a 3GPP system, a conceptual link connecting between NFs in a 5G system is defined as a reference point or an interface. The following exemplifies a reference point included in a 5G system architecture represented in FIG. 1B.
N1: a reference point or an interface between the terminal 110 and the AMF 130
N2: a reference point or an interface between the base station 120 and the AMF 130
N3: a reference point or an interface between the base station 120 and the UPF 150
N4: a reference point or an interface between the SMF 140 and the UPF 150
N5: a reference point or an interface between the PCF 170 and the AF196
N6: a reference point or an interface between the UPF 150 and the DN 155
N7 a reference point or an interface between the SMF 140 and the PCF 170
N8: a reference point or an interface between the UDM 180 and AMF 130
N9: a reference point or an interface between two core UPFs (e.g., the UPF 150)
N10: a reference point or an interface between the UDM 180 and the SMF 140
N11: a reference point or an interface between the AMF 130 and the SMF 140
N12: a reference point or an interface between the AMF 130 and the AUSF 195
N13: a reference point or an interface between the UDM 180 and the AUSF 195
N14: a reference point or an interface between two AMFs (e.g., AMF 130)
N15: a reference point between the PCF 170 and the AMF 130 in case of a non-roaming scenario, and a reference point or an interface between the PCF 170 and the AMF 130 in a visited network in case of roaming scenario

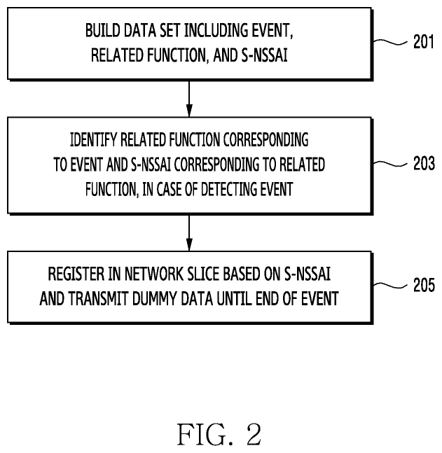

FIG. 2 illustrates an example of operations of a terminal (e.g., the terminal 110 of FIG. 1A or the terminal 110 of FIG. 1B) using a network slice. The network slice may be described as a technique providing a single physical network infrastructure by separating it into a plurality of independent virtual networks. The network slice may indicate a logical network providing a service-specific connection to a data network DN (e.g., DN 155) associated with a specific service application. Since each network slice is provided according to requirements of a specific service, a function, or an application, various performance needs may be satisfied. For example, a terminal of a slice user who subscribes a service may receive a function, a performance, and security optimized for the service by being connected to an service application via the network slice. Network operators may optimize a resource for each slice, maintain service quality, and meet various needs of a customer.

Referring to FIG. 2, in an operation 201, the terminal 110 may build a data set including an event, a related function, and S-NSSAI. For example, the event may include an event related to an emergency situation. For example, the event may include an event related to an urgent situation. The related function may be described as a function (e.g., an application) of the terminal 110 corresponding to the event. The related function may be referred to as the function of the terminal 110 executed based on the terminal 110 detecting the event. For example, the related function may include an application executed based on the terminal 110 detecting the event.

The single network slice selection assistance information (S-NSSAI) indicates information necessary for the terminal 110 to connect to the network slice. The S-NSSAI may include a slice/service type (SST) for indicating a function and/or a feature. For example, in the case of an eMBB service, a value of the SST may point ‘1’. For example, in case of an ultra reliable low latency communications (URLLC) service, a value of the SST may point ‘2’. For example, in case of a massive Internet over things (MioT) service, a value of the SST may point ‘3’. The S-NSSAI may include only the SST or may include the SST and a slice differentiator (SD). The SD may be used as an identifier for distinguishing groups in a corresponding service (a function and/or a feature). The S-NSSAI may be used to identify (or determine) the network slice to which the terminal 110 is to be connected. That is, the S-NSSAI may include the identifier of the network slice. In the present disclosure, the S-NSSAI may include on-demand S-NSSAI. The on-demand S-NSSAI may be referred to as a slice identifier dynamically generated or allocated according to a request of the terminal 110 in a network. The on-demand S-NSSAI may be set by a request of the terminal 110 in the network (e.g., a SMF 140 and a NSSF 191). The network (e.g., the NSSF 191) may provide the terminal 110 with a list of the on-demand S-NSSAI set according to a network policy. The list of the on-demand S-NSSAI may be referred to as an allowed S-NSSAI list. According to an embodiment, the S-NSSAI in the data set may be mapped with an event and the related function. For example, the S-NSSAI in the data set may indicate information necessary for the terminal 110 to connect with the network slice for executing the related function (e.g., the application).

In an operation 203, in case of detecting an event, the terminal 110 may identify the related function corresponding to the event and the S-NSSAI corresponding to the related function. In case of detecting the event, the terminal 110 may execute the related function corresponding to the event in the data set and identify the S-NSSAI corresponding to the related function. For example, the terminal 110 may identify a medical application based on detecting heart rate data obtained via a heart rate sensor of the terminal 110 greater than a threshold value. The terminal 110 may identify the S-NSSAI for execution of the medical application in the data set based on detecting the heart rate data obtained via the heart rate sensor of the terminal 110 greater than the threshold value.

According to an embodiment, the data set may be exemplified in Table 1. However, an embodiment is not limited thereto.

TABLE 1

| Event | Related function | S-NSSAI |
|---|---|---|
| Event for heart rate problem | Call doctor | S-NSSAI 1 |
| situation | Executing medical | S-NSSAI 2 |
| | application | |
| Event for blood pressure | Call doctor | S-NSSAI 3 |
| problem situation | Call your daughter | S-NSSAI 4 |
| Event for traffic accident | Executing insurance | S-NSSAI 5 |
| situation | application | |
| | Call 119 | S-NSSAI 6 |
| Event for situation of | Executing map application | S-NSSAI 7 |
| encountering wild animal | Call Wildlife Center | S-NSSAI 8 |
| Event for lost child | Executing map application | S-NSSAI 7 |
| situation | | |
| Event for fire situation | Call 119 | S-NSSAI 6 |
| Event for earthquake | Call 119 | S-NSSAI 6 |
| situation | | |
| Event for tsunami | Executing taxi reservation | S-NSSAI 6 |
| situation | application | |
| Event for volcanic | Call 119 | S-NSSAI 9 |
| eruption situation | | |
| Event for lost situation | Executing map application | S-NSSAI 7 |
| | Call your wife | S-NSSAI 1 |

For example, referring to Table 1, the terminal 110 may execute a call application and identify S-NSSAI 3, based on detecting an event (e.g., a situation in which a value of blood pressure data exceeds a threshold value) for a situation with a problem in blood pressure. For example, the terminal 110 may execute an insurance application and identify S-NSSAI 5 based on detecting an event for a traffic accident situation.

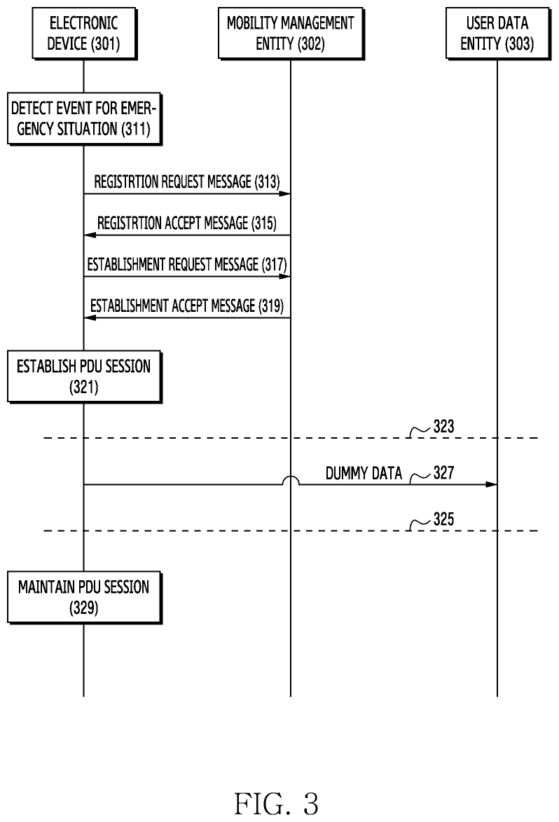

In an operation 205, the terminal 110 may register in the network slice based on S-NSSAI and transmit dummy data until an end of the event. The terminal 110 may execute a process registering to the network slice based on the S-NSSAI identified in the operation 203. The process of the terminal 110 registering in the network slice will be described and illustrated with reference to FIG. 3. After registering in the network slice, the terminal 110 may establish a protocol data unit (PDU) session between the terminal 110 and a UPF (e.g., the UPF 150). The PDU session may be referred to as a logical connection for data transmission between the terminal 110 and the network. The PDU session may manage transmission and reception of data between the terminal 110 and the UPF 150. The process by which the PDU session is established between the terminal 110 and the UPF 150 will be described and illustrated with reference to FIG. 3.

The terminal 110 may transmit the dummy data to the UPF 150 until an end of the event. By transmitting the dummy data to the UPF 150 before the end of the event, the terminal 110 may cause a reset of a PDU session inactivity timer before the PDU session inactivity timer expires. When the PDU session inactivity timer expires, the PDU session may be released. Since the PDU session inactivity timer is reset before the PDU session inactivity timer expires, the PDU session may be maintained or continued without being released. The PDU session inactivity timer may be defined in a network standard (e.g., 3GPP TS 23.501 and 3GPP TS 23.502). The PDU session inactivity timer may be configured in the UPF 150 according to a policy of a network operator. The PDU session inactivity timer may be run in case that a data packet is not transmitted or received via the PDU session. The running PDU session inactivity timer may be restarted in case that the data packet is transmitted or received via the PDU session. In case that the PDU session inactivity timer expires, the UPF 150 may report the PDU session inactivity event to a SMF (e.g., the SMF 140) to cause the SMF 140 to release the PDU session. While the PDU session is released, the SMF 140 may indicate a cause (e.g., expiration of the PDU session inactivity timer) of the release. An AMF (e.g., the AMF 130) may receive a release notification of the PDU session. The release notification may include the cause of the release. The AMF 130 may remove a network slice of S-NSSAI corresponding to the PDU session, or start (or run) a slice deregistration inactivity timer, by triggering a UE configuration update procedure.

The slice deregistration inactivity timer may be defined in a network standard (e.g., a 3GPP standard). The slice deregistration inactivity timer may be managed by the SMF 140. The terminal 110 may receive on-demand S-NSSAI information from the SMF 140. The on-demand S-NSSAI information may include a list of one or more on-demand S-NSSAIs and a value of a slice deregistration inactivity timer. The slice deregistration inactivity timer may be run in case that the PDU session according to the S-NSSAI is released. The slice deregistration inactivity timer may be run in case that the S-NSSAI of a corresponding slice is included in an allowed S-NSSAI list, but the PDU session is not established. The allowed S-NSSAI list may be indicated as the list of the on-demand S-NSSAI set according to the network policy. The slice deregistration inactivity timer may be reset in case that a first PDU session is established. S-NSSAI of a S-NSSAAI corresponding slice is removed from the allowed S-NSSAI list, the slice deregistration inactivity timer may be reset. In case that the slice deregistration inactivity timer expires, the AMF 130 and the terminal 110 may remove a corresponding S-NSSAI from the allowed S-NSSAI list. In case that the slice deregistration inactivity timer expires, the AMF 130 may transmit a configuration update command message to the terminal 110.

According to an embodiment, the terminal 110 may register the terminal 110 in the network slice so that the terminal 110 may access a service based on the S-NSSAI. The terminal 110 may trigger always-on PDU session indication. The always-on PDU session indication may be described as information for establishing the always-on PDU session. An always-on PDU session may be described as a PDU session that always remain active. The terminal 110 may establish the always-on PDU session between the terminal 110 and the UPF 150 based on a always-on PDU session indication request message.

FIG. 3 illustrates an example of operations of an electronic device 301 (e.g., the terminal 110 of FIG. 1A or the terminal 110 of FIG. 1B) for maintaining a protocol data unit (PDU) session. A mobility management entity 302 may include the AMF 130 of FIG. 1B. A user data entity 303 may include the UPF 150 of FIG. 1B. In an embodiment of the present disclosure, S-NSSAI may include on-demand S-NSSAI.

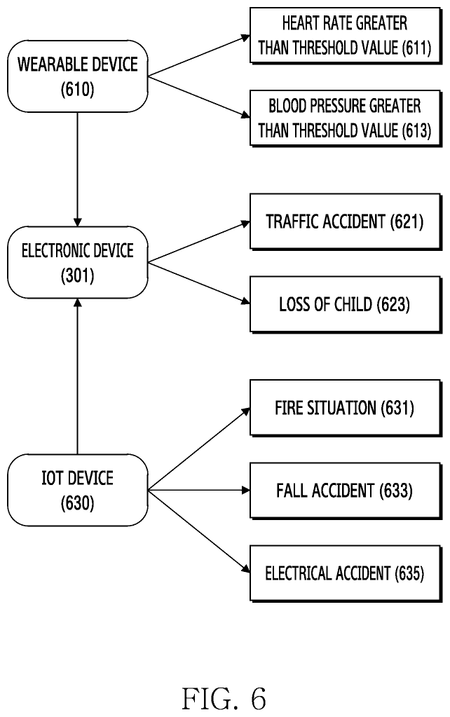

Referring to FIG. 3, in an operation 311, the electronic device 301 may detect an event for an emergency situation. For example, the emergency situation may include a heart rate problem situation, a blood pressure problem situation, a traffic accident situation, a situation of encountering wild animals, a lost child situation, a fire situation, an earthquake situation, a tsunami situation, a volcanic eruption situation, and/or a lost situation. However, an embodiment is not limited. For example, the event may include an event included in the data set exemplified in FIG. 2. The event may be detected based on data obtained via a sensor (e.g., a heart rate sensor, a blood pressure sensor, and an inertial measurement unit (IMU) sensor) of the electronic device 301. For example, the event may include a value of heart rate data obtained via the heart rate sensor of the electronic device 301 being greater than or equal to a threshold value. For example, the event may include a value of IMU data obtained via the IMU sensor of the electronic device 301 being greater than or equal to a threshold value. For example, the event may include a value of blood pressure data obtained via the blood pressure sensor of the electronic device 301 being greater than or equal to a threshold value. For example, the event may include receiving a notification message indicating the emergency situation from an external electronic device (e.g., a server). For example, the notification message may include a public warning system (PWS) message. For example, the notification message may include type information of the emergency situation. The type of emergency situation may include the earthquake situation, the fire situation, and/or the tsunami situation. For example, the notification message may include an altitude of an occurrence point of the emergency situation and/or a latitude of the occurrence point of the emergency situation. As an example without limitation, the external electronic device may include a wearable device and an Internet of Things (IOT) device. The electronic device 301 receiving the notification message from the wearable device and the IOT device will be described and exemplified in more detail with reference to FIG. 6.

According to an embodiment, the electronic device 301 may execute an application in response to detecting the event. For example, the application may be an example of a related function of the data set of FIG. 2. The electronic device 301 may execute a preset application in response to a preset event by using the data set of FIG. 2. The electronic device 301 may identify S-NSSAI corresponding to the preset application, by using the data set. For example, the electronic device 301 may execute a call application in response to an event in which a notification message indicating the emergency situation is received from the external electronic device. For example, the electronic device 301 may identify S-NSSAI corresponding to the call application. The electronic device 301 may transmit a registration request message including the identified S-NSSAI to the mobility management entity 302.

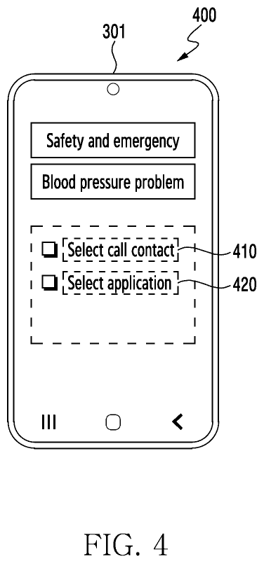

According to an embodiment, the electronic device 301 may build or generate the data set according to a user setting of the electronic device 301. The electronic device 301 building the data set according to the user setting will be described and illustrated with reference to FIG. 4.

According to an embodiment, the electronic device 301 may build or generate the data set, by using an artificial intelligence model (e.g., a neural network) in the electronic device 301. As an example without limitation, the electronic device 301 may determine an application to be executed in the emergency situation by providing data indicating the event for the emergency situation to the artificial intelligence model. The artificial intelligence model may include a model trained by using user information (e.g., an application history executed by the user in the emergency situation) of the electronic device 301.

In an operation 313, the electronic device 301 may transmit, via communication circuitry of the electronic device 301, the registration request message to the mobility management entity 302. The registration request message may be described as a request message transmitted by the electronic device 301 to access a network slice. The registration request message may include S-NSSAI for an event. The electronic device 301 may transmit, via the communication circuitry of the electronic device 301, the registration request message including identified S-NSSAI to the mobility management entity 302, by using the data set. The registration request message may include a request for a list of S-NSSAI.

In an operation 315, the electronic device 301 may receive, via the communication circuitry the electronic device 301, a registration accept message from the mobility management entity 302. The registration accept message may include the S-NSSAI for the event. The registration accept message may include a previously preset S-NSSAI list of the network. The registration accept message may include a list of S-NSSAI that the electronic device 301 may access. The list of S-NSSAI that the electronic device 301 may access may be dynamically determined according to a network policy. The list of S-NSSAI that the electronic device 301 may access may be indicated by the allowed S-NSSAI list exemplified in FIG. 2. As an example without limitation, the registration accept message may include a list of S-NSSAI to which access of the electronic device 301 is restricted.

According to an embodiment, in case that the S-NSSAI identified in the operation 313 is not included in the allowed S-NSSAI list, the electronic device 301 may transmit, via the communication circuitry of the electronic device 301, a registration request message including other S-NSSAI included in the allowed S-NSSAI list to the mobility management entity 302.

In an operation 317, the electronic device 301 may transmit, via the communication circuitry of the electronic device 301, an establishment request message for a PDU session to the mobility management entity 302. The establishment request message for the PDU session may be described as a request message transmitted to set the PDU session. As an example, the establishment request message for the PDU session may be referred to as a PDU session establishment request message. The establishment request message for the PDU session may include S-NSSAI and quality of service (QOS) requirements. The PDU session may be a logical connection with a network corresponding to the S-NSSAI of the operation 313 and the operation 315. The S-NSSAI may be included in the allowed S-NSSAI list exemplified in the operation 315.

In an operation 319, the electronic device 301 may receive, via the communication circuitry of the electronic device 301, an establishment accept message for the PDU session from the mobility management entity 302.

In an operation 321, the electronic device 301 may establish the PDU session between the electronic device 301 and the user data entity 303 in response to receiving the establishment accept message for the PDU session. Based on the electronic device 301 establishing the PDU session, a slice deregistration inactivity timer managed by an SMF (e.g., an SMF 140) may be reset. The electronic device 301 may, via the PDU session, transmit data to the user data entity 303 and receive data from the user data entity 303.

According to an embodiment, the electronic device 301 may not transmit, via the PDU session, data (e.g., a data packet) to the user data entity 303 since a time point 323. For example, since an application corresponding to the PDU session has not been used since the time point 323, the electronic device 301 may not have the data to be transmitted to the user data entity 303. The electronic device 301 may not receive, via the PDU session, the data from the user data entity 303, since the time point 323. The user data entity 303 may run the PDU session inactivity timer described in FIG. 2 at the time point 323. A time point 325 may be indicated as a time point at which the PDU session inactivity timer expires. If there is no transmission of the data or reception of the data using the PDU session between the electronic device 301 and the user data entity 303 by the time point 325, the PDU session may be released.

In an operation 327, the electronic device 301 may transmit dummy data to the user data entity 303 via the PDU session until an end of the event to maintain the PDU session. The dummy data may indicate data continuously transmitted by the electronic device 301 so that the PDU session is not released due to expiration of the PDU session inactivity timer. Hereinafter, in the present disclosure, the dummy data is referred to as the dummy data in terms of not including data for a specific purpose, but may be referred to as a trigger signal, trigger data, a trigger sequence, a virtual signal, virtual data, a preset signal, a preset sequence, preset data, specific data, wake-up data, a wake-up signal, a wake-up sequence, reset data, a reset signal, a reset sequence, initiation data, an initiation signal, an initiation sequence, and/or a technical term equivalent thereto. As an example without limitation, the electronic device 301 may transmit a sequence of a predefined pattern, and the user data entity 303 may identify the sequence of the predefined pattern. The sequence of the predefined pattern may be used to inform an intention of a user to maintain the PDU session of the electronic device 301. The dummy data may be defined as arbitrary data for reviewing functionality of a system instead of actual data. The dummy data may be used to reset the PDU session inactivity timer before the PDU session inactivity timer expires. For example, the electronic device 301 may transmit the dummy data to the user data entity 303 via the PDU session between the time point 323 when the PDU session inactivity timer is run and the time point 325 when the PDU session inactivity timer expires. As the electronic device 301 transmits the dummy data to the user data entity 303 via the PDU session, the PDU session inactivity timer run in the user data entity 303 may be reset. Since the PDU session inactivity timer run in the user data entity 303 is reset, the PDU session may not be released.

In the present disclosure, the end of the event may include the electronic device 301 determining or identifying that the emergency situation ends. For example, the electronic device 301 may determine the end of the event based on a value of the blood pressure data obtained via the blood pressure sensor being reduced less than or equal to the threshold value. The electronic device 301 may determine the end of the event according to the end of the application executed in response to the event for the emergency situation. For example, the electronic device 301 may determine the end of the event as the medical application executed in response to the event for an increase in blood pressure is ended.

According to an embodiment, the electronic device 301 may transmit transmission control protocol (TCP) data to the user data entity 303 via the PDU session until the end of the event to maintain the PDU session.

In an operation 329, the electronic device 301 may maintain the PDU session established between the electronic device 301 and the user data entity 303 due to transmission of the dummy data. The electronic device 301 may maintain the established PDU session until the end of the emergency situation (e.g., the end of the executed medical application, the end of the executed call application, the end of the executed insurance application, and the end of the executed map application). While maintaining the PDU session, the electronic device 301 may perform communication via a pre-established PDU session without a separate registration procedure (e.g., the operation 313, and the operation 315) and a separate PDU session establishment procedure (e.g., the operation 317, and the operation 319). The electronic device 301 may transmit data for intended S-NSSAI to the user data entity 303 or receive data for the intended S-NSSAI from the user data entity 303 via the pre-established PDU session. The electronic device 301 may perform communication without time required for the registration procedure (e.g., the operation 313, or the operation 315) and the PDU session establishment procedure (e.g., the operation 317, or the operation 319) in the emergency situation.

According to an embodiment, the electronic device 301 may detect another event for the emergency situation while maintaining the PDU session. The electronic device 301 may identify S-NSSAI for the other event. The electronic device 301 may perform communication via the pre-established PDU session without the separate registration procedure (e.g., the operation 313, or the operation 315) and the separate PDU session establishment procedure (e.g., the operation 317, or the operation 319), based on the S-NSSAI for the another event corresponding to the pre-established PDU session. In other words, the electronic device 301 may refrain from performing the separate registration procedure. The electronic device 301 may refrain from performing the separate PDU session establishment procedure. The electronic device 301 may transmit data (or a signal) regarding the other event to the user data entity 303 via the pre-established PDU session.

According to an embodiment, the electronic device 301 may maintain the PDU session by transmitting the dummy data before the PDU session inactivity timer for the maintained PDU session expires. The electronic device 301 may maintain the PDU session until the end of the event. Since the electronic device 301 maintains the PDU session, the electronic device 301 may provide a seamless service to the user. The electronic device 301 may enhance a user experience by providing the seamless service.

FIG. 4 illustrates an example of an electronic device 301 (e.g., the terminal 110 of FIG. 1A or the terminal 110 of FIG. 1B) building a data set according to a user setting.

Referring to FIG. 4, in a state 400, the electronic device 301 may display a user interface for building a data set via a display of the electronic device 301. For example, the user interface may be used to build the data set exemplified in FIG. 2 according to the user setting. For example, the user interface may be used to set a related function corresponding to an event for an emergency situation.

In the state 400, the user interface may be used to set a related function corresponding to an event for a situation in which there is a blood pressure problem. For example, the event for the situation in which there is the blood pressure problem may include a case in which a value of blood pressure data obtained via a blood pressure sensor of the electronic device 301 is greater than or equal to a threshold value. In the state 400, the user interface may include a visual object 410 and a visual object 420. The electronic device 301 may set to execute a call application in case that a value of the blood pressure data obtained via the blood pressure sensor of the electronic device 301 is greater than or equal to the threshold value in response to a user input to the visual object 410. For example, the electronic device 301 may set a counterpart number of a call, in response to the user input to the visual object 410. In response to a user input to the visual object 420, the electronic device 301 may set an application to be executed in case that a value of the blood pressure data obtained via the blood pressure sensor of the electronic device 301 is greater than or equal to the threshold value.

In FIG. 4, the user interface setting the related function corresponding to the event for the situation in which there is the blood pressure problem is illustrated, but this is only an example. As an example without limitation, the electronic device 301 may display the user interface setting the related function corresponding to the event exemplified in FIG. 2 via the display of the electronic device 301.

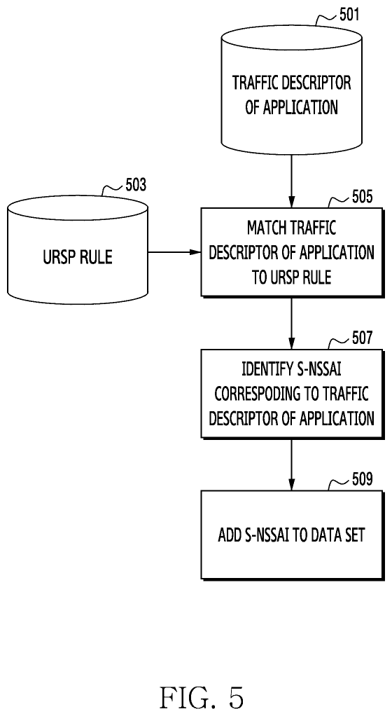

FIG. 5 illustrates an example of operations of an electronic device (e.g., the electronic device 301, the terminal 110 of FIG. 1A, or the terminal 110 of FIG. 1B) building a data set. In an embodiment of the present disclosure, S-NSSAI may include on-demand S-NSSAI.

Referring to FIG. 5, the electronic device 301 may identify S-NSSAI corresponding to an application based on a traffic descriptor 501 and a user equipment route selection policy (URSP) rule 503 of the application. The traffic descriptor 501 of the application may be described as information including a requirement (e.g., a traffic requirement, and a QOS requirement) of the application. The traffic descriptor 501 of the application may be used to provide a network slice according to the requirement of the application. In other words, the traffic descriptor 501 of the application may be used to map optimal S-NSSAI to the application. For example, the application may include the application in the data set exemplified in FIG. 2. For example, the application may include a call application, a medical application, a map application, an insurance application, and/or a taxi reservation application.

The URSP rule 503 may be described as a policy of a network for defining a path of traffic according to a service requirement of the electronic device 301 (e.g., UE). The URSP rule 503 may be used to determine or identify S-NSSAI according to the requirement of the application of the electronic device 301. The electronic device 301 may receive the URSP rule 503 from a network (e.g., the SMF 140).

In an operation 505, the electronic device 301 may match the traffic descriptor 501 of the application to the URSP rule 502. For example, the electronic device 301 may analyze the traffic descriptor 501 and the URSP rule 502 of the application.

In an operation 507, the electronic device 301 may identify S-NSSAI corresponding to the traffic descriptor 501 of the application by matching the traffic descriptor 501 of the application to the URSP rule 502.

In an operation 509, the electronic device 301 may add the identified S-NSSAI to the data set. The electronic device 301 may add data including the identified S-NSSAI, an application corresponding to the identified S-NSSAI, and an event corresponding to the application to the data set.

FIG. 6 illustrates an example of an electronic device (e.g., the terminal 110 of FIG. 1A and the terminal 110 of FIG. 1B) receiving a notification message from a wearable device 610 and an IOT device 630. In an embodiment of the present disclosure, S-NSSAI may include on-demand S-NSSAI.

Referring to FIG. 6, the electronic device 301 may receive the notification message from the wearable device 610 via communication circuitry of the electronic device 301. The electronic device 301 may detect an event for an emergency situation by receiving the notification message from the wearable device 610.

According to an embodiment, the wearable device 610 may include a heart rate sensor. The wearable device 610 may obtain heart rate data while a user wears the wearable device 610. For example, the wearable device 610 may identify a heart rate 611 greater than a threshold value, by using the heart rate data. The wearable device 610 may transmit a notification message indicating the heart rate 611 greater than the threshold value to the electronic device 301. The electronic device 301 may execute a medical application in response to receiving the notification message indicating the heart rate 611 greater than the threshold value. The electronic device 301 may identify S-NSSAI corresponding to the medical application, by using a data set. The electronic device 301 may execute the operation 313 of FIG. 3 based on the identified S-NSSAI.

According to an embodiment, the wearable device 610 may include a blood pressure sensor. The wearable device 610 may obtain blood pressure data while the user wears the wearable device 610. The wearable device 610 may identify a blood pressure 613 greater than a threshold value, by using the blood pressure data. The wearable device 610 may transmit a notification message indicating the blood pressure 613 greater than the threshold value to the electronic device 301. The electronic device 301 may execute a call application in response to receiving the notification message indicating the blood pressure 613 greater than the threshold value. The electronic device 301 may identify S-NSSAI corresponding to the call application, by using the data set. The electronic device 301 may execute the operation 313 of FIG. 3 based on the identified S-NSSAI.

According to an embodiment, the electronic device 301 may receive a notification message from the IOT device 630 via the communication circuitry of the electronic device 301. The electronic device 301 may detect an event for an emergency situation by receiving the notification message from the IOT device 630. For example, the IOT device 630 may include a smart refrigerator, a smart TV, a smart speaker, and/or a smart camera. However, it is not limited thereto. The IOT device 630 may detect a fire situation 631, a fall accident 633, and/or an electrical accident 635. The electronic device 301 may receive a notification message indicating the fire situation 631 from the IOT device 630. The electronic device 301 may execute a call application corresponding to the fire situation 631, by using the data set. The electronic device 301 may identify S-NSSAI corresponding to the call application, by using the data set. The electronic device 301 may receive a notification message indicating the fall accident 633 from the IOT device 630. The electronic device 301 may execute a medical application corresponding to the fall accident 633, by using the data set. The electronic device 301 may identify S-NSSAI corresponding to the medical application, by using the data set. The electronic device 301 may receive a notification message indicating the electrical accident 635 from the IOT device 630. The electronic device 301 may execute a call application corresponding to the electrical accident 635, by using the data set. The electronic device 301 may identify S-NSSAI corresponding to the call application, by using the data set.

According to an embodiment, the electronic device 301 may detect an event related to a traffic accident 621 and an event related to a loss of a child 623 via a sensor of the electronic device 301. For example, the electronic device 301 may detect the event related to the traffic accident 621 in case that a value of IMU data obtained via a IMU sensor of the electronic device 301 is greater than a threshold value. The electronic device 301 may execute an insurance application corresponding to the traffic accident 621, by using the data set. The electronic device 301 may identify S-NSSAI corresponding to the insurance application, by using the data set. For example, the electronic device 301 may detect the event related to the loss of the child 623, by using a position sensor of the electronic device 301. The electronic device 301 may execute a map application corresponding to the loss of the child 623, by using the data set. The electronic device 301 may identify S-NSSAI corresponding to the map application, by using the data set.

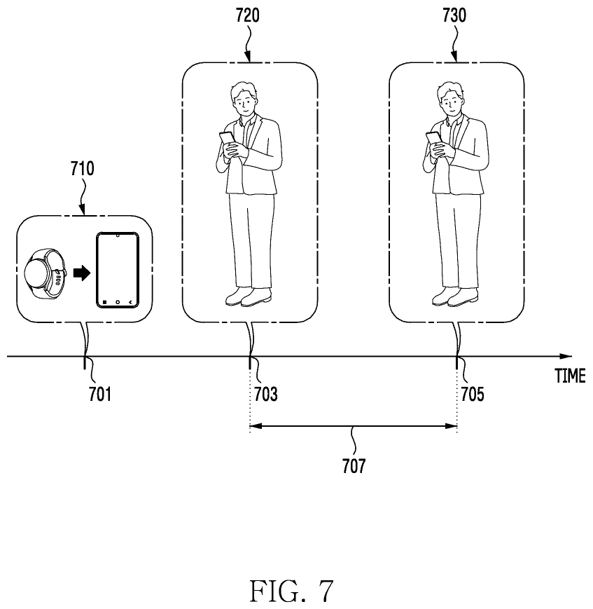

FIG. 7 illustrates an example of an electronic device (e.g., the electronic device 301, the terminal 110 of FIG. 1A, or the terminal 110 of FIG. 1B) providing a seamless service to a user. In an embodiment of the present disclosure, S-NSSAI may include on-demand S-NSSAI.

Referring to FIG. 7, a state 710 may be indicated as a state in which the electronic device 301 detects an event receiving a notification message indicating an emergency situation from a wearable device (e.g., a wearable device 610) at a time point 701. In the state 710, the electronic device 301 may perform the operations exemplified in FIG. 3 in response to detecting the event. The electronic device 301 may establish and maintain a PDU session between the electronic device 301 and a user data entity (e.g., a user data entity 303).

According to an embodiment, the operation 313, the operation 315, the operation 317, and the operation 319 of FIG. 3 may not be executed based on detecting the event in which the electronic device 301 receives the notification message indicating the emergency situation from the wearable device 610 after the time point 701. While maintaining the PDU session, the electronic device 301 may perform communication via a pre-established PDU session without a separate registration procedure (e.g., the operation 313, or the operation 315) and a separate PDU session establishment procedure (e.g., the operation 317, or the operation 319). After the time point 701, based on detecting the event in which the electronic device 301 receives the notification message indicating the emergency situation from the wearable device 610, data may be transmitted to the user data entity 303 via the maintained PDU session.

A state 720 may be indicated as a state in which a user executes an application of the electronic device 301 at a time point 703. Since the electronic device 301 establishes and maintains the PDU session at the time point 701, the electronic device 301 may transmit data for intended S-NSSAI to the user data entity 303 via the pre-established PDU session at the time point 703. While maintaining the PDU session, the electronic device 301 may perform communication via the pre-established PDU session without the separate registration procedure (e.g., the operation 313, or the operation 315) and the separate PDU session establishment procedure (e.g., the operation 317, or the operation 319). In other words, since the electronic device 301 maintains the PDU session established at the time point 701, the electronic device 301 may seamlessly provide a service of the application at the time point 703. The electronic device 301 may perform communication without time required for the registration procedure (e.g., the operation 313, or the operation 315) and the PDU session establishment procedure (e.g., the operation 317, or the operation 319) in the emergency situation.

The state 730 may be indicated as a state in which the application of the electronic device 301 is executed by the user at a time point 705 after a period 707 has elapsed from the time point 703. The user may not use the application of the electronic device 301 during the period 707. For example, the user may have left the electronic device 301 unattended during the period 707. For example, the period 707 may be longer than expiration time of a PDU session inactivity timer.

According to an embodiment, the electronic device 301 may maintain the PDU session even though the electronic device 301 is left during the period 707 longer than the expiration time of the PDU session inactivity timer at the time point 705. The electronic device 301 may transmit dummy data to the user data entity 303 via the PDU session before the PDU session inactivity timer expires. The electronic device 301 may cause reset of the PDU session inactivity timer in the user data entity 303, by transmitting the dummy data to the user data entity 303 via the PDU session. The electronic device 301 may maintain the PDU session since the time point 701.

Since the electronic device 301 maintains the PDU session at the time point 705, the electronic device 301 may seamlessly provide a service of the application to the user. The electronic device 301 may enhance a user experience by reducing waiting time (or delay time) of the user.

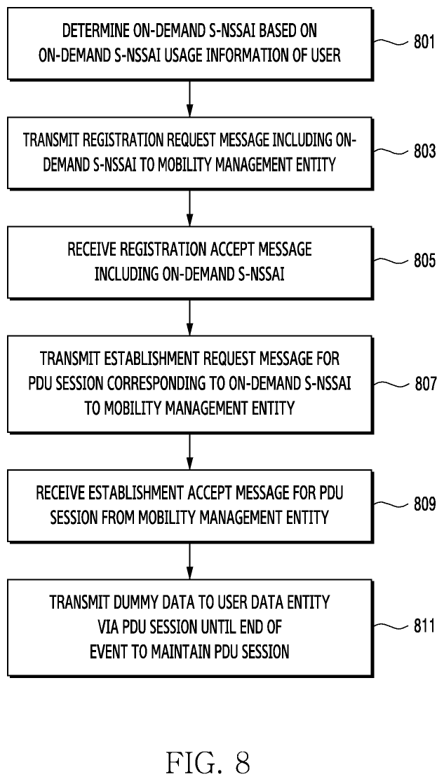

FIG. 8 illustrates an example of operations of an electronic device (e.g., an electronic device 301, the terminal 110 of FIG. 1A, or the terminal 110 of FIG. 1B) for maintaining a PDU session.

Referring to FIG. 8, in an operation 801, the electronic device 301 may determine on-demand S-NSSAI based on on-demand S-NSSAI usage information of the user. The on-demand S-NSSAI usage information of the user may include usage information of an application using a network slice. For example, the on-demand S-NSSAI usage information of the user may include usage time of the application set by the user. For example, the on-demand S-NSSAI usage information of the user may include time information using the application, position information using the application, and on-demand S-NSSAI of the application. For example, information indicating that a mail application is used in a company from 1:00 to 2:00 every day and on-demand S-NSSAI of the mail application may be included in the on-demand S-NSSAI usage information of the user. In case that the electronic device 301 is positioned in the company from 1:00 to 2:00, the electronic device 301 may identify the on-demand S-NSSAI of the mail application. The on-demand S-NSSAI usage information of the user may be referred to as a schedule.

According to an embodiment, the on-demand S-NSSAI usage information of the user may include information indicating that the user periodically uses a specific application at a specific time. The electronic device 301 may determine or identify on-demand S-NSSAI of the specific application at the specific time according to the on-demand S-NSSAI usage information of the user.

In an operation 803, the electronic device 301 may transmit a registration request message including the on-demand S-NSSAI to a mobility management entity (e.g., the mobility management entity 302) via communication circuitry of the electronic device 301. The registration request message may be described as a request message transmitted by the electronic device 301 to access a network slice. The registration request message may include S-NSSAI for an event. The operation 803 of FIG. 8 may correspond to the operation 313 of FIG. 3.

In the operation 805, the electronic device 301 may receive, via the communication circuitry of the electronic device 301, a registration accept message from the mobility management entity 302. The registration accept message may include the S-NSSAI for the event. The registration accept message may include a previously preset S-NSSAI list of a network. The registration accept message may include a list of S-NSSAI that the electronic device 301 may access. The list of S-NSSAI that the electronic device 301 may access may be dynamically determined according to a network policy. The list of S-NSSAI that the electronic device 301 may access may be indicated by the allowed S-NSSAI list exemplified in FIG. 2. The operation 805 of FIG. 8 may correspond to the operation 315 of FIG. 3.

In operation 807, the electronic device 301 may transmit, via the communication circuitry of the electronic device 301, an establishment request message for a PDU session to the mobility management entity 302. The establishment request message for the PDU session may be described as a request message transmitted to set the PDU session. As an example, the establishment request message for the PDU session may be referred to as the PDU session establishment request message. The establishment request message for the PDU session may include the S-NSSAI and quality of service (QOS) requirements. The operation 807 of FIG. 8 may correspond to the operation 317 of FIG. 3.

In an operation 809, the electronic device 301 may receive, via the communication circuitry of the electronic device 301, an establishment accept message for the PDU session from the mobility management entity 302. The operation 809 of FIG. 8 may correspond to the operation 319 of FIG. 3.

In an operation 811, the electronic device 301 may transmit dummy data to a user data entity 303 via the PDU session until an end of the event to maintain the PDU session. The dummy data may be used to reset the PDU session inactivity timer before the PDU session inactivity timer expires. The dummy data may indicate data continuously transmitted by the electronic device 301 so that the PDU session is not released due to expiration of the PDU session inactivity timer. Hereinafter, in the present disclosure, the dummy data is referred to as dummy data in terms of not including data of a specific purpose, but may be referred to as a trigger signal, trigger data, a trigger sequence, a virtual signal, virtual data, a preset signal, a preset sequence, preset data, specific data, wake-up data, a wake-up signal, a wake-up sequence, reset data, a reset signal, a reset sequence, initiation data, an initiation signal, an initiation sequence, and/or a technical term equivalent thereto. As an example without limitation, the electronic device 301 may transmit a sequence of a predefined pattern, and the user data entity 303 may identify the sequence of the predefined pattern. The sequence of the predefined pattern may be used to inform an intention of a user to maintain the PDU session of the electronic device 301. For example, the electronic device 301 may transmit the dummy data to the user data entity 303 via the PDU session between a time point 323 when the PDU session inactivity timer is run and the time point 325 when the PDU session inactivity timer expires. As the electronic device 301 transmits the dummy data to the user data entity 303 via the PDU session, the PDU session inactivity timer run in the user data entity 303 may be reset. Since the PDU session inactivity timer run in the user data entity 303 is reset, the PDU session may not be released. The operation 811 of FIG. 8 may correspond to the operation 327 of FIG. 3.

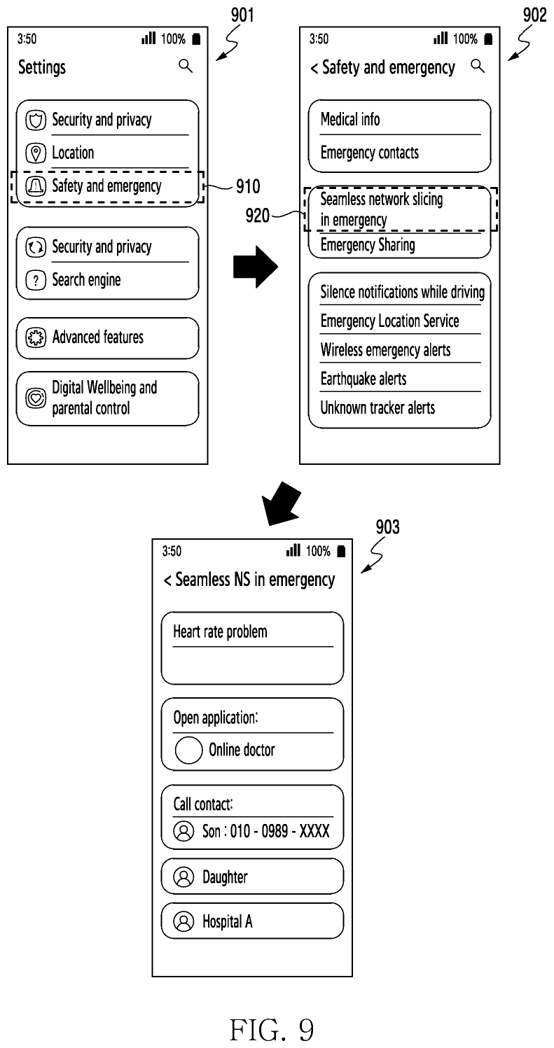

FIG. 9 illustrates an example of a screen including a user interface for setting a function for maintaining a PDU session of an electronic device (e.g., the electronic device 301, the terminal 110 of FIG. 1A, or the terminal 110 of FIG. 1B).

Referring to FIG. 9, a screen 901 may be displayed by the electronic device 301 via a display of the electronic device 301. The screen 901 may include a menu 910 for setting regarding an emergency situation service. The electronic device 301 may change the screen 901 to a screen 902 in response to identifying an input for the menu 910 for setting regarding the emergency situation service. The screen 901 is merely exemplary for convenience of a description, and embodiments of the present disclosure are not limited thereto.

In response to identifying the input to the menu 910 for setting the emergency situation service, the electronic device 301 may display the screen 902 for a detailed setting regarding the emergency situation service. For example, the screen 902 may include a menu for medical information, a menu for an emergency call, a menu for a wireless emergency alarm, a menu for an earthquake alarm, and/or a menu 920 for a seamless network slice. The menu 920 for the seamless network slice may be described as a menu for setting a function for maintaining the PDU session. For example, the electronic device 301 may change the screen 902 to a screen 903 in response to identifying an input to the menu 920 for the seamless network slice. The screen 902 is merely exemplary for convenience of a description, and embodiments of the present disclosure are not limited thereto.

The electronic device 301 may display the screen 903 in response to identifying the input to the menu 920 for the seamless network slice. The electronic device 301 may provide a function for building the data set exemplified in FIG. 2 while displaying the screen 903. A state in which the electronic device 301 displays the screen 903 may include the state 400 of the electronic device 301 illustrated in FIG. 4. While displaying the screen 903, the electronic device 301 may set an application to be executed based on detecting an event for the emergency situation in response to a user input. For example, while displaying the screen 903 in case that detecting the event for the emergency situation, the electronic device 301 may set contact information of another party to perform a call using a call application.

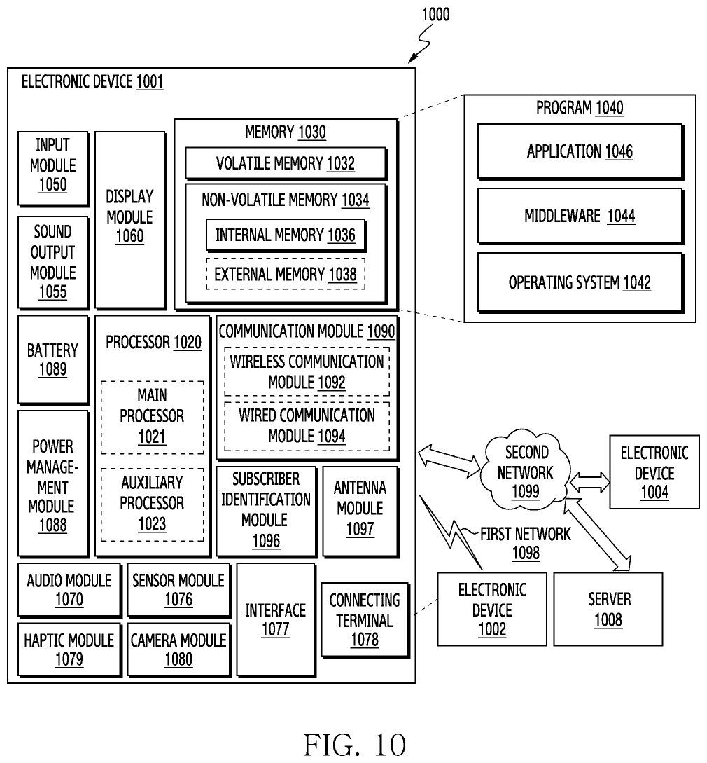

FIG. 10 is a block diagram illustrating an electronic device 1001 (e.g., the terminal 110 of FIG. 1A, the terminal 110 of FIG. 1B, and the electronic device 301 of FIG. 3) in a network environment 1000 according to various embodiments.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled, directly or indirectly, with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021. Each processor herein comprises processing circuitry.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mm Wave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

In an embodiment according to the present disclosure, the electronic device (e.g., the electronic device 301) may establish a PDU session between the electronic device 301 and a user data entity (e.g., the user data entity 303). The electronic device 301 may maintain the established PDU session. Since the electronic device 301 maintains the PDU session, the electronic device 301 provide a seamless service to a user. The electronic device 301 may enhance a user experience of the electronic device 301 by providing the seamless service. Since the electronic device 301 maintains the PDU session, the user experience of the electronic device 301 may be enhanced by reducing waiting time (or delay time) of the user.

The effects that may be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 1040) including one or more instructions that are stored in a storage medium (e.g., internal memory 1036 or external memory 1038) that is readable by a machine (e.g., the terminal 110 of FIG. 1A, the terminal 110 of FIG. 1B, the electronic device 301 of FIG. 3, and the electronic device 1001 of FIG. 10). For example, a processor (e.g., the processor 1020) of the machine (e.g., the terminal 110 of FIG. 1A, the terminal 110 of FIG. 1B, the electronic device 301 of FIG. 3, and the electronic device 1001 of FIG. 10) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this document are not limited to those described above, and other technical problems not mentioned herein will be clearly understood by those having ordinary knowledge in the art to which the present disclosure belongs, from the following description.

As described above, an electronic device may comprise communication circuitry. The electronic device may comprise memory comprising one or more storage mediums, storing instructions. The electronic device may comprise at least one processor comprising processing circuitry. The instructions, when executed by the at least one processor individually and/or collectively, may cause the electronic device to detect an event for an emergency situation. The instructions, when executed by the at least one processor individually and/or collectively, may cause the electronic device to transmit, via the communication circuitry, a registration request message including on-demand single network slice selection assistance information (S-NSSAI) for the event to a mobility management entity. The instructions, when executed by the at least one processor individually and/or collectively, may cause the electronic device to receive, via the communication circuitry, a registration accept message including the on-demand S-NSSAI. The instructions, when executed by the at least one processor individually and/or collectively, may cause the electronic device to transmit, via the communication circuitry, an establishment request message for a protocol data unit (PDU) session corresponding to the on-demand S-NSSAI to the mobility management entity. The instructions, when executed by the at least one processor individually and/or collectively, may cause the electronic device to receive, via the communication circuitry, an establishment accept message for the PDU session from the mobility management entity. The instructions, when executed by the at least one processor individually and/or collectively, may cause the electronic device to, in response to receiving the establishment accept message, transmit dummy data to a user data entity via the PDU session until an end of the event to maintain the PDU session. The dummy data may be used to reset a PDU session inactivity timer before the PDU session inactivity timer for the PDU session expires.

According to an embodiment, the instructions, when executed by the at least one processor individually and/or collectively, may cause the electronic device to, in response to the event indicating that a value of heart rate data obtained via a heart rate sensor of the electronic device is greater than a threshold value, execute a medical application. The instructions, when executed by the at least one processor individually and/or collectively, may cause the electronic device to identify the on-demand S-NSSAI corresponding to the medical application. The instructions, when executed by the at least one processor individually and/or collectively, may cause the electronic device to transmit, via the communication circuitry, the registration request message including the identified on-demand S-NSSAI to the mobility management entity.

According to an embodiment, the instructions, when executed by the at least one processor individually and/or collectively, may cause the electronic device to, in response to the event indicating that a value of inertial measurement unit (IMU) data obtained via an IMU sensor of the electronic device is greater than a threshold value, execute an insurance application. The instructions, when executed by the at least one processor individually and/or collectively, may cause the electronic device to identify the on-demand S-NSSAI corresponding to the insurance application. The instructions, when executed by the at least one processor individually and/or collectively, may cause the electronic device to transmit, via the communication circuitry, the registration request message including the identified on-demand S-NSSAI to the mobility management entity.

According to an embodiment, the instructions, when executed by the at least one processor individually and/or collectively, may cause the electronic device to, in response to the event indicating that a value of blood pressure data obtained via a blood pressure sensor of the electronic device is greater than a threshold value, execute a call application. The instructions, when executed by the at least one processor individually and/or collectively, may cause the electronic device to identify the on-demand S-NSSAI corresponding to the call application. The instructions, when executed by the at least one processor individually and/or collectively, may cause the electronic device to transmit, via the communication circuitry, the registration request message including the identified on-demand S-NSSAI to the mobility management entity.

According to an embodiment, the instructions, when executed by the at least one processor individually and/or collectively, may cause the electronic device, in response to the event of receiving a notification message indicating the emergency situation from an external electronic device via the communication circuitry, execute a call application. The instructions, when executed by the at least one processor individually and/or collectively, may cause the electronic device to identify the on-demand S-NSSAI corresponding to the call application. The instructions, when executed by the at least one processor individually and/or collectively, may cause the electronic device to transmit, via the communication circuitry, the registration request message including the identified on-demand S-NSSAI to the mobility management entity. The emergency situation may include an earthquake situation, a fire situation, and a tsunami situation.

According to an embodiment, the instructions, when executed by the at least one processor individually and/or collectively, may cause the electronic device to determine an application to be executed in the emergency situation by providing data indicating the event to a user behavior model. The instructions, when executed by the at least one processor individually and/or collectively, may cause the electronic device to identify the on-demand S-NSSAI corresponding to the application. The instructions, when executed by the at least one processor individually and/or collectively, may cause the electronic device to transmit, via the communication circuitry, the registration request message including the identified on-demand S-NSSAI to the mobility management entity.

According to an embodiment, the instructions, when executed by the at least one processor individually and/or collectively, may cause the electronic device to, after transmitting the dummy data to the user data entity via the PDU session, based on detecting another event for the emergency situation, refrain from transmitting a second establishment request message for the PDU session to the mobility management entity. The instructions, when executed by the at least one processor individually and/or collectively, may cause the electronic device to, after transmitting the dummy data to the user data entity via the PDU session, based on detecting another event for the emergency situation, transmit a signal regarding the other event to the user data entity via the PDU session established in response to receiving the establishment accept message.

As described above, a method performed by an electronic device with communication circuitry may comprise detecting an event for an emergency situation. The method may comprise transmitting, via the communication circuitry, a registration request message including on-demand single network slice selection assistance information (S-NSSAI) for the event to a mobility management entity. The method may comprise receiving, via the communication circuitry, a registration accept message including the on-demand S-NSSAI. The method may comprise transmitting, via the communication circuitry, an establishment request message for a protocol data unit (PDU) session corresponding to the on-demand S-NSSAI to the mobility management entity. The method may comprise receiving, via the communication circuitry, an establishment accept message for the PDU session from the mobility management entity. The method may comprise, in response to receiving the establishment accept message, transmitting dummy data to a user data entity via the PDU session until an end of the event to maintain the PDU session. The dummy data may be used to reset a PDU session inactivity timer before the PDU session inactivity timer for the PDU session expires.

According to an embodiment, the method may comprise, in response to the event indicating that a value of heart rate data obtained via a heart rate sensor of the electronic device is greater than a threshold value, executing a medical application. The method may comprise identifying the on-demand S-NSSAI corresponding to the medical application. The method may comprise transmitting, via the communication circuitry, the registration request message including the identified on-demand S-NSSAI, to the mobility management entity.

According to an embodiment, the method may comprise, in response to the event indicating that a value of inertial measurement unit (IMU) data obtained via an IMU sensor of the electronic device is greater than a threshold value, executing an insurance application. The method may comprise identifying the on-demand S-NSSAI corresponding to the insurance application. The method may comprise, via the communication circuitry, transmitting the registration request message including the identified on-demand S-NSSAI, to the mobility management entity.

According to an embodiment, the method may comprise, in response to the event indicating that a value of blood pressure data obtained via a blood pressure sensor of the electronic device is greater than a threshold value, executing a call application. The method may comprise identifying the on-demand S-NSSAI corresponding to the call application. The method may comprise transmitting, via the communication circuitry, the registration request message including the identified on-demand S-NSSAI, to the mobility management entity.

According to an embodiment, the method may comprise, in response to the event of receiving a notification message indicating the emergency situation from an external electronic device via the communication circuitry, executing a call application. The method may comprise identifying the on-demand S-NSSAI corresponding to the call application. The method may comprise, via the communication circuitry, transmitting the registration request message including the identified on-demand S-NSSAI, to the mobility management entity. The emergency situation may include an earthquake situation, a fire situation, and a tsunami situation.

According to an embodiment, the method may comprise determining an application to be executed in the emergency situation by providing data indicating the event to a user behavior model. The method may comprise identifying the on-demand S-NSSAI corresponding to the application. The method may comprise transmitting, via the communication circuitry, the registration request message including the identified on-demand S-NSSAI to the mobility management entity. According to an embodiment, the method may comprise, after transmitting the dummy data to the user data entity via the PDU session, based on detecting another event for the emergency situation, refraining from transmitting a second establishment request message for the PDU session to the mobility management entity. According to an embodiment, the method may comprise, after transmitting the dummy data to the user data entity via the PDU session, based on detecting another event for the emergency situation, transmitting a signal regarding the other event to the user data entity via the PDU session established in response to receiving the establishment accept message.

As described above, in a non-transitory computer readable storage medium storing one or more programs, the one or more programs may comprise instructions to, when executed by an electronic device with communication circuitry, cause the electronic device to transmit, via the communication circuitry, a registration request message including on-demand single network slice selection assistance information (S-NSSAI) for the event to a mobility management entity. The one or more programs may comprise instructions to, when executed by the electronic device, cause the electronic device to receive, via the communication circuitry, a registration accept message including the on-demand S-NSSAI. The one or more programs may comprise instructions to, when executed by the electronic device, cause the electronic device to transmit, via the communication circuitry, an establishment request message for a protocol data unit (PDU) session corresponding to the on-demand S-NSSAI to the mobility management entity. The one or more programs may comprise instructions to, when executed by the electronic device, cause the electronic device to receive, via the communication circuitry, an establishment accept message for the PDU session from the mobility management entity. The one or more programs may comprise instructions to, when executed by the electronic device, cause the electronic device to, in response to receiving the establishment accept message, transmit dummy data to a user data entity via the PDU session until an end of the event to maintain the PDU session. The dummy data may be used to reset a PDU session inactivity timer before the PDU session inactivity timer for the PDU session expires.

According to an embodiment, the one or more programs may comprise instructions to, when executed by the electronic device, cause the electronic device to, in response to the event indicating that a value of heart rate data obtained via a heart rate sensor of the electronic device is greater than a threshold value, execute a medical application. The one or more programs may comprise instructions to, when executed by the electronic device, cause the electronic device to identify the on-demand S-NSSAI corresponding to the medical application. The one or more programs may comprise instructions to, when executed by the electronic device, cause the electronic device to transmit, via the communication circuitry, the registration request message including the identified on-demand S-NSSAI, to the mobility management entity.

According to an embodiment, the one or more programs may comprise instructions to, when executed by the electronic device, cause the electronic device to, in response to the event indicating that a value of inertial measurement unit (IMU) data obtained via an IMU sensor of the electronic device is greater than a threshold value, execute an insurance application. The one or more programs may comprise instructions to, when executed by the electronic device, cause the electronic device to identify the on-demand S-NSSAI corresponding to the insurance application. The one or more programs may comprise instructions to, when executed by the electronic device, cause the electronic device to transmit, via the communication circuitry, the registration request message including the identified on-demand S-NSSAI, to the mobility management entity.

According to an embodiment, the one or more programs may comprise instructions to, when executed by the electronic device, cause the electronic device to, in response to the event indicating that a value of blood pressure data obtained via a blood pressure sensor of the electronic device is greater than a threshold value, execute a call application. The one or more programs may comprise instructions to, when executed by the electronic device, cause the electronic device to identify the on-demand S-NSSAI corresponding to the call application. The one or more programs may comprise instructions to, when executed by the electronic device, cause the electronic device to transmit, via the communication circuitry, the registration request message including the identified on-demand S-NSSAI, to the mobility management entity.

According to an embodiment, the one or more programs may comprise instructions to, when executed by the electronic device, cause the electronic device to, in response to the event of receiving a notification message indicating the emergency situation from an external electronic device via the communication circuitry, execute a call application. The one or more programs may comprise instructions to, when executed by the electronic device, cause the electronic device to identify the on-demand S-NSSAI corresponding to the call application. The one or more programs may comprise instructions to, when executed by the electronic device, cause the electronic device to transmit, via the communication circuitry, the registration request message including the identified on-demand S-NSSAI, to the mobility management entity. The emergency situation may include an earthquake situation, a fire situation, and a tsunami situation.

According to an embodiment, the one or more programs may comprise instructions to, when executed by the electronic device, cause the electronic device to determine an application to be executed in the emergency situation by providing data indicating the event to a user behavior model. The one or more programs may comprise instructions to, when executed by the electronic device, cause the electronic device to identify the on-demand S-NSSAI corresponding to the application. The one or more programs may comprise instructions to, when executed by the electronic device, cause the electronic device to transmit, via the communication circuitry, the registration request message including the identified on-demand S-NSSAI, to the mobility management entity.

According to an embodiment, the one or more programs may comprise instructions to, when executed by the electronic device, cause the electronic device to, after transmitting the dummy data to the user data entity via the PDU session, based on detecting another event for the emergency situation, refrain from transmitting a second establishment request message for the PDU session to the mobility management entity. The one or more programs may comprise instructions to, when executed by the electronic device, cause the electronic device to, after transmitting the dummy data to the user data entity via the PDU session, based on detecting another event for the emergency situation, transmit a signal regarding the other event to the user data entity via the PDU session established in response to receiving the establishment accept message.

Each embodiment herein may be used in combination with any other embodiment(s) described herein.

No claim element is to be construed under the provisions of 35 U.S.C. § 112, sixth paragraph, unless the element is expressly recited using the phrase “means for” or “means”.

What is claimed is:

1. An electronic device comprising:
communication circuitry;
memory, comprising one or more storage media, storing instructions; and
at least one processor comprising processing circuitry,
wherein the instructions, when executed by the at least one processor individually and/or collectively, cause the electronic device to:
detect an event for an emergency situation,
transmit, via at least the communication circuitry, a registration request message including on-demand single network slice selection assistance information (S-NSSAI) for the event to a mobility management entity,
receive, via at least the communication circuitry, a registration accept message including the on-demand S-NSSAI,
transmit, via at least the communication circuitry, an establishment request message for a protocol data unit (PDU) session corresponding to the on-demand S-NSSAI to the mobility management entity,
receive, via at least the communication circuitry, an establishment accept message for the PDU session from the mobility management entity, and
in response to receiving the establishment accept message, transmit dummy data to a user data entity via the PDU session at least until an end of the event to maintain the PDU session, and
wherein the dummy data is used to reset a PDU session inactivity timer before the PDU session inactivity timer for the PDU session expires.

2. The electronic device of claim 1, wherein the instructions, when executed by the at least one processor individually and/or collectively, cause the electronic device to:
in response to the event indicating that a value of heart rate data obtained via a heart rate sensor of the electronic device is at least as great as a threshold value, execute a medical application,
identify the on-demand S-NSSAI corresponding to the medical application, and
transmit, via at least the communication circuitry, the registration request message including the identified on-demand S-NSSAI to the mobility management entity.

3. The electronic device of claim 1, wherein the instructions, when executed by the at least one processor individually and/or collectively, cause the electronic device to:
in response to the event indicating that a value of inertial measurement unit (IMU) data obtained via an IMU sensor of the electronic device is at least as great as a threshold value, execute an insurance application,
identify the on-demand S-NSSAI corresponding to the insurance application, and
transmit, via at least the communication circuitry, the registration request message including the identified on-demand S-NSSAI to the mobility management entity.

4. The electronic device of claim 1, wherein the instructions, when executed by the at least one processor individually and/or collectively, cause the electronic device to:
in response to the event indicating that a value of blood pressure data obtained via a blood pressure sensor of the electronic device is at least as great as a threshold value, execute a call application,
identify the on-demand S-NSSAI corresponding to the call application, and
transmit, via at least the communication circuitry, the registration request message including the identified on-demand S-NSSAI to the mobility management entity.

5. The electronic device of claim 1, wherein the instructions, when executed by the at least one processor individually and/or collectively, cause the electronic device to:
in response to the event of receiving a notification message indicating the emergency situation from an external electronic device via at least the communication circuitry, execute a call application,
identify the on-demand S-NSSAI corresponding to the call application, and
transmit, via at least the communication circuitry, the registration request message including the identified on-demand S-NSSAI to the mobility management entity, and
wherein the emergency situation includes at least one of an earthquake situation, a fire situation, and/or a tsunami situation.

6. The electronic device of claim 1, wherein the instructions, when executed by the at least one processor individually and/or collectively, cause the electronic device to:
determine an application to be executed in the emergency situation, at least by providing data indicating the event to a user behavior model,
identify the on-demand S-NSSAI corresponding to the application, and
transmit, via at least the communication circuitry, the registration request message including the identified on-demand S-NSSAI to the mobility management entity.

7. The electronic device of claim 1, wherein the instructions, when executed by the at least one processor individually and/or collectively, cause the electronic device to:
after transmitting the dummy data to the user data entity via the PDU session, based on detecting another event for the emergency situation:
refrain from transmitting a second establishment request message for the PDU session to the mobility management entity, and
transmit a signal regarding the other event to the user data entity via the PDU session established in response to receiving the establishment accept message.

8. A method performed by an electronic device, the method comprising:
detecting an event for an emergency situation,
transmitting a registration request message including on-demand single network slice selection assistance information (S-NSSAI) for the event to a mobility management entity,
receiving a registration accept message including the on-demand S-NSSAI,
transmitting an establishment request message for a protocol data unit (PDU) session corresponding to the on-demand S-NSSAI to the mobility management entity,
receiving an establishment accept message for the PDU session from the mobility management entity, and
in response to receiving the establishment accept message, transmitting dummy data to a user data entity via the PDU session at least until an end of the event to maintain the PDU session, and
wherein the dummy data is used to reset a PDU session inactivity timer before the PDU session inactivity timer for the PDU session expires.

9. The method of claim 8, comprising:
in response to the event indicating that a value of heart rate data obtained via a heart rate sensor of the electronic device is at least as great as a threshold value, executing a medical application,
identifying the on-demand S-NSSAI corresponding to the medical application, and
transmitting the registration request message including the identified on-demand S-NSSAI to the mobility management entity.

10. The method of claim 8, comprising:
in response to the event indicating that a value of inertial measurement unit (IMU) data obtained via an IMU sensor of the electronic device is at least as great as a threshold value, executing an insurance application,
identifying the on-demand S-NSSAI corresponding to the insurance application, and
transmitting, the registration request message including the identified on-demand S-NSSAI to the mobility management entity.

11. The method of claim 8, comprising:
in response to the event indicating that a value of blood pressure data obtained via a blood pressure sensor of the electronic device is at least as great as a threshold value, executing a call application,
identifying the on-demand S-NSSAI corresponding to the call application, and
transmitting, the registration request message including the identified on-demand S-NSSAI to the mobility management entity.

12. The method of claim 8, comprising:
in response to the event of receiving a notification message indicating the emergency situation from an external electronic device, executing a call application,
identifying the on-demand S-NSSAI corresponding to the call application, and
transmitting, the registration request message including the identified on-demand S-NSSAI to the mobility management entity, and
wherein the emergency situation includes at least one of an earthquake situation, a fire situation, and/or a tsunami situation.

13. The method of claim 8, comprising:
determining an application to be executed in the emergency situation, at least by providing data indicating the event to a user behavior model,
identifying the on-demand S-NSSAI corresponding to the application, and
transmitting, the registration request message including the identified on-demand S-NSSAI to the mobility management entity.

14. The method of claim 8, further comprising:
after transmitting the dummy data to the user data entity via the PDU session, based on detecting another event for the emergency situation:
refraining from transmitting a second establishment request message for the PDU session to the mobility management entity, and
transmitting a signal regarding the other event to the user data entity via the PDU session established in response to receiving the establishment accept message.

15. A non-transitory computer readable storage medium storing one or more programs, the one or more programs comprising instructions to, when executed by an electronic device with communication circuitry, cause the electronic device to:
detect an event for an emergency situation,
transmit, via at least the communication circuitry, a registration request message including on-demand single network slice selection assistance information (S-NSSAI) for the event to a mobility management entity,
receive, via at least the communication circuitry, a registration accept message including the on-demand S-NSSAI,
transmit, via at least the communication circuitry, an establishment request message for a protocol data unit (PDU) session corresponding to the on-demand S-NSSAI to the mobility management entity,
receive, via at least the communication circuitry, an establishment accept message for the PDU session from the mobility management entity, and
in response to receiving the establishment accept message, transmit dummy data to a user data entity via the PDU session at least until an end of the event to maintain the PDU session, and
wherein the dummy data is used to reset a PDU session inactivity timer before the PDU session inactivity timer for the PDU session expires.

16. The non-transitory computer readable storage medium of claim 15,
wherein the one or more programs, comprising the instructions to, when executed by the electronic device, cause the electronic device to:
in response to the event indicating that a value of heart rate data obtained via a heart rate sensor of the electronic device is at least as great as a threshold value, execute a medical application,
identify the on-demand S-NSSAI corresponding to the medical application, and
transmit, via at least the communication circuitry, the registration request message including the identified on-demand S-NSSAI to the mobility management entity.

17. The non-transitory computer readable storage medium of claim 15,
wherein the instructions, comprising the instructions to, when executed by the electronic device, cause the electronic device to:
in response to the event indicating that a value of inertial measurement unit (IMU) data obtained via an IMU sensor of the electronic device is at least as great as a threshold value, execute an insurance application,
identify the on-demand S-NSSAI corresponding to the insurance application, and
transmit, via at least the communication circuitry, the registration request message including the identified on-demand S-NSSAI to the mobility management entity.

18. The non-transitory computer readable storage medium of claim 15,
wherein the instructions, comprising the instructions to, when executed by the electronic device, cause the electronic device to:
in response to the event indicating that a value of blood pressure data obtained via a blood pressure sensor of the electronic device is at least as great as a threshold value, execute a call application,
identify the on-demand S-NSSAI corresponding to the call application, and
transmit, via at least the communication circuitry, the registration request message including the identified on-demand S-NSSAI to the mobility management entity.

19. The non-transitory computer readable storage medium of claim 15,
wherein the instructions, comprising the instructions to, when executed by the electronic device, cause the electronic device to:
in response to the event of receiving a notification message indicating the emergency situation from an external electronic device via at least the communication circuitry, execute a call application,
identify the on-demand S-NSSAI corresponding to the call application, and
transmit, via at least the communication circuitry, the registration request message including the identified on-demand S-NSSAI to the mobility management entity, and
wherein the emergency situation includes at least one of an earthquake situation, a fire situation, and/or a tsunami situation.

20. The non-transitory computer readable storage medium of claim 15,
wherein the instructions, comprising the instructions to, when executed by the electronic device, cause the electronic device to:
determine an application to be executed in the emergency situation, at least by providing data indicating the event to a user behavior model,
identify the on-demand S-NSSAI corresponding to the application, and
transmit, via at least the communication circuitry, the registration request message including the identified on-demand S-NSSAI to the mobility management entity.
